(19) United States
(12) Patent Application Publication
(10) Pub. No.: US 2012/0000491 A1
(43) Pub. Date: Jan. 5, 2012

(54) Apparatus and Method for Cleaning an Electronic Device

(75) Inventors: Phillip J. Jakes, Durham, NC (US); Brian W. Killebrew, Raleigh, NC (US)

(73) Assignee: Lenovo (Singapore) Pte. Ltd., Singapore (SG)

(21) Appl. No.: 12/829,319

(22) Filed: Jul. 1, 2010

(51) Int. Cl. B08B 5/02

(52) U.S. Cl. 134/22.18; 15/406

(57) ABSTRACT

Apparatus which has an electronic device housing; components housed within the housing; and a fluid flow conducting conduit within the housing and communicating with one of the components housed within the housing. The conduit enables conduction to the one component of a flow of pressurized fluid which removes accumulated debris from the one component. Method of cleaning in which a flow of pressurized fluid is directed to remove debris.

### FIELD AND BACKGROUND

What is here described relates to the cleaning of electronic devices, and particularly to removing dust or debris accumulating within the housing of a computer system which might otherwise impair the operation of the system.

As computer systems become more powerful, smaller, and used in more places, keeping cooling fans and heatsinks free of accumulated dust and debris becomes more important. This may be particularly true of notebook systems. When fans and/or heatsinks become overly coated in dust, they become less efficient in cooling, leading to increased internal temperature which accelerates wear on the system. Should the fan eventually fail to adequately cool, the system may go into thermal shutdown. If such a failure is incorrectly diagnosed, then unnecessary parts may be replaced. At a minimum, an expensive service call may be initiated to clean the system. Often, cleaning fans and heatsinks requires the partial disassembly of the system by an authorized service technician, who then can blow dust off the fan using compressed air. This requires time of skilled technicians as well as potentially distributing dust around the system.

### SUMMARY

The technology here disclosed is embodied, in one example, in an apparatus which has an electronic device housing; electronic device components housed within the housing; and a fluid flow conducting conduit within the housing and communicating with one of the electronic device components housed within the housing. The conduit enables conduction to the one electronic device component of a flow of pressurized fluid which removes accumulated debris from the one component.

In other embodiments, the apparatus may be a computer system and particularly a notebook computer system. In such apparatus, the housing which encloses the conduit may have a peripheral edge in which a port is formed through which pressurized gas may be introduced into the conduit. The gas, which may be compressed air, may be directed to a fan to blow dust from the fan and expel it from the housing.

The technology is also practiced as a method, in which a housing for electronic device components is provided which has a fluid flow conducting conduit extending within the housing to an electronic device component within the housing; and the removal of accumulated debris from the component is enabled by directing a flow of pressurized fluid through the conduit to the component.

### BRIEF DESCRIPTION OF DRAWINGS

Some of the purposes of the technology here disclosed having been stated, others will appear as the description proceeds, when taken in connection with the accompanying drawings, in which:

FIG. 1 is a schematic illustration of an electronic device, particularly a computer system;

FIG. 2 is plan view of the interior of a notebook computer system from which the keyboard has been lifted so as to reveal the electronic components which enable operation of the device;

FIG. 3 is a view illustrating an operator applying a pressurized fluid to a port shown in FIGS. 2 and 3and enabling the flow of that fluid to remove dust from a component of the system of FIGS. 2 and 3.

### DETAILED DESCRIPTION OF EMBODIMENTS

While the present technology will be described more fully hereinafter with reference to the accompanying drawings, in which preferred embodiments are shown, it is to be understood at the outset of the description which follows that persons of skill in the appropriate arts may modify the technology here described while still achieving the favorable results of the technology. Accordingly, the description which follows is to be understood as being a broad, teaching disclosure directed to persons of skill in the appropriate arts, and not as limiting upon what has been claimed.

As stated above, what is here described and taught is directed to electronic devices. Such devices typically include heat generating components and components which deal with heat generated by dissipating that heat externally of the device so as to keep the heat generating components sufficiently cooled for effective operation of the device. While described and illustrated hereinafter with reference to particular devices, namely computer systems and particularly those known as notebook computer systems, it is contemplated that the technology described will find broad application and usefulness with a range of electronic devices and the specifics illustrated and discussed are to be understood as a teaching example of broadly applicable technology.

The term “circuit” or “circuitry” may appear in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

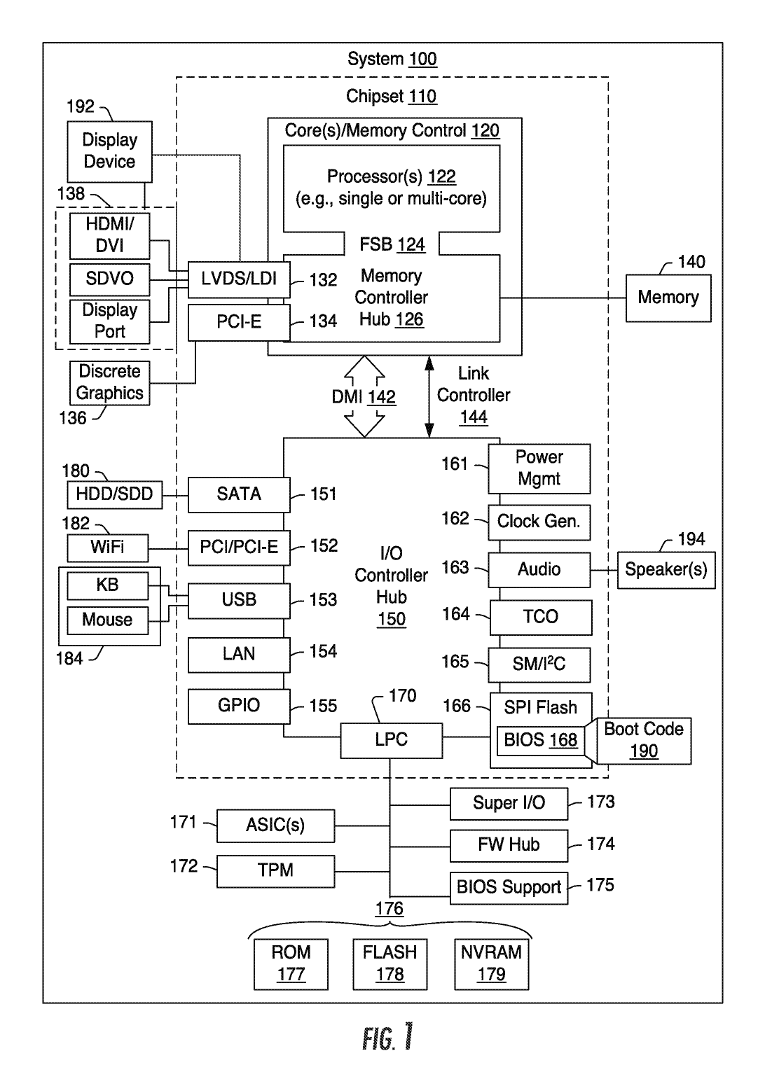

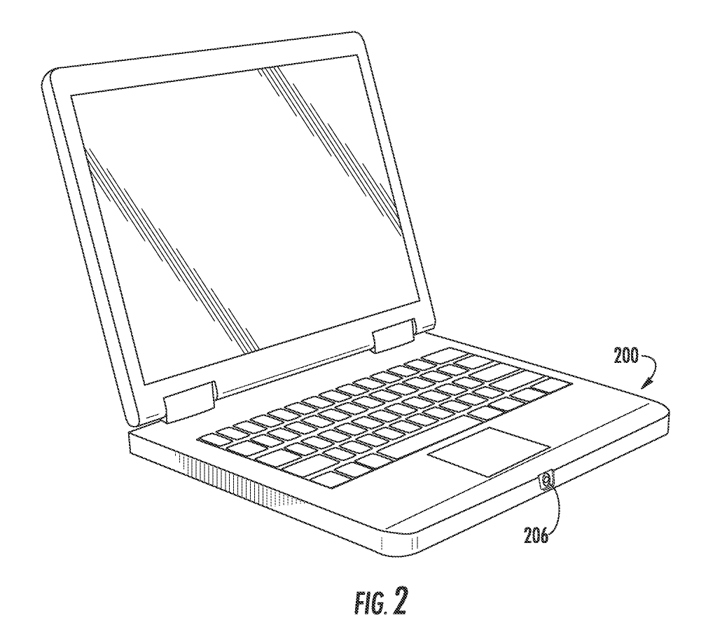

While various exemplary circuits or circuitry are discussed, FIG. 1 depicts a block diagram of an illustrative exemplary computer system 100. The system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine may include other features or only some of the features of the system 100.

The system 100 of FIG. 1 includes a so-called chipset 110 (a group of integrated circuits, or chips, that work together, chipsets) with an architecture that may vary depending on manufacturer (e.g., INTEL®, AMD®, etc.). The architecture of the chipset 110 includes a core and memory control group 120 and an I/O controller hub 150 that exchange information (e.g., data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (e.g., single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (e.g., to provide support for a type of RAM that may be referred to as “system memory”). The memory controller hub 126 further includes a LVDS interface 132 for a display device 192 (e.g., a CRT, a flat panel, a projector, etc.). A block 138 includes some technologies that may be supported via the LVDS interface 132 (e.g., serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (e.g., for HDDs, SDDs, etc.), a PCI-E interface 152 (e.g., for wireless connections 182), a USB interface 153 (e.g., for input devices 184 such as keyboard, mice, cameras, phones, storage, etc.), a network interface 154 (e.g., LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (e.g., for speakers 194), a TCO interface 164, a system management bus interface 165, and SPI Flash 166, which can include BIOS 168 and boot code 190. The I/O hub controller 150 may include gigabit Ethernet support.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. As described herein, a device may include fewer or more features than shown in the system 100 of FIG. 1.

With an electronic device such as the computer system of FIG. 1, components within the system generate heat during operation of the device. Temperature rises associated with that heat may interfere with device operation. In particular, processors such as the processor 122 are subject to impairment of operation due to elevated temperatures and in some instances will cease working if generated heat is not dissipated. For these reasons, it is conventional to provide heat sinks for removing heat from components and fans to circulate air and remove heat from within a housing enclosing the components and dissipate the heat externally of the system.

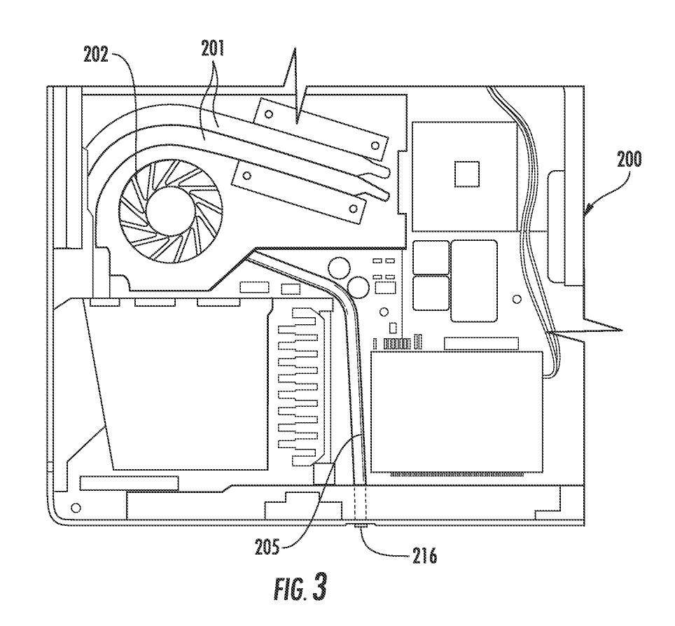

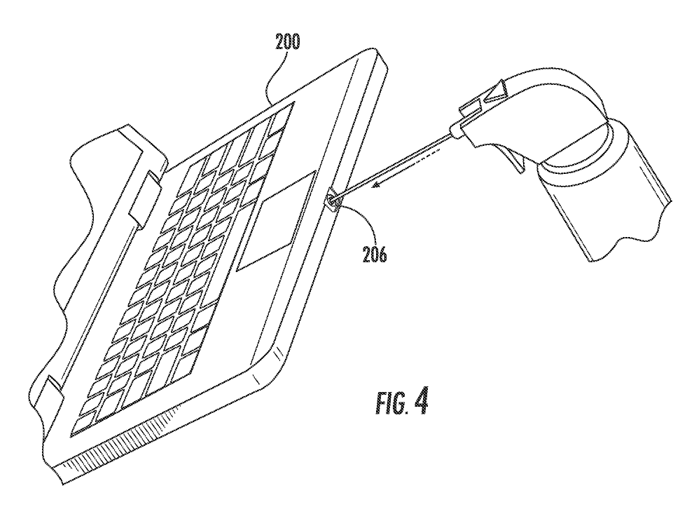

Referring now to FIGS. 2 through 4, what is there shown includes a housing 200 for the electronic device, which as illustrated is a computer system of the sort known as a notebook computer system. Within the housing 200 are enclosed a plurality of components which together enable the operation of the system. These typically include a processor such as the processor 122 of FIG. 1 (obscured from view in FIG. 3 by a cover), a heat sink for capturing heat generated by operation of the processor 122 and here illustrated by heat pipes 201, and a fan 202 which circulates a flow of air in the housing 200 to dissipate the heat generated by operation of the device. Typically, the fan draws air from outside the housing 200 through an appropriate opening or port and impels the flow of air within and from the housing.

As pointed out herein above, the fan is subject to the accumulation of debris, particularly dust, as a consequence of drawing air from the ambient surrounding of the system into the housing. Such an accumulation interferes with the efficient transfer of heat and can disrupt the operation of the system. While dust may be a culprit in general office use, other debris may accumulate depending upon the environment of use of the system. Examples may be textile or other fibers, and even more chunky materials such as wood chips if free in the environment of use and subject to being drawn into the system.

In accordance with the technology here described, the apparatus has a fluid flow conducting conduit 205 (FIG. 3) extending within the housing 200 and communicating with one of the electronic device components housed within the housing. In the particular embodiment illustrated, the conduit 205 extends toward the fan 202 from adjacent a peripheral edge of the housing 200. The conduit enables conduction to the one electronic device component—here the fan 202—of a flow of pressurized fluid which removes accumulated debris from the component. Preferably, the conduit is a tube of a suitable material.

The device has an external port 206 (FIGS. 2 through 4) disposed at a location along a peripheral side edge of the housing 200 and communicating with the conduit 205. The port provides an access from outside the housing 200 for the introduction of pressurized fluid. As shown particularly in FIG. 4, a technician may use a source of pressurized fluid, typically a canister of compressed air, to direct of flow into the port 206 and through the conduit 205 to the fan 202. When a blast of air is applied, debris and dust otherwise accumulated on the fan will be loosened and blown from the fan to the exterior of the system.

While the port and conduit are so shown and described, persons of skill in the art and those applying the technology to differing environments of use will understand that the port may be located on any exterior surface. Further, if the device design is such as to permit it, the conduit may be shortened significantly and the port placed very close to the component to be cleaned. As one example of such a design, the port may be placed either on the keyboard surface or the surface opposite the keyboard surface of a notebook computer system so as to more directly apply the blast of fluid to the component to be cleaned. Shortening the conduit in this manner, perhaps to a minimal length, may increase the effectiveness of the fluid applied.

Further, the blast of fluid may be, and may on some designs be needed to be, directed to a component which would accumulate debris in such a manner as to obstruct the transfer of heat in some other manner. Such a component might, while not directly engaged in the transfer of heat, be in some way blocking or disrupting the heat transfer pathway.

Such an operation thus flows as a method in which a housing is provided for electronic device components which has a fluid flow conducting conduit extending within the housing to an electronic device component within the housing; and the removal of accumulated debris from the component by directing a flow of pressurized fluid through the conduit to the component is enabled. The housing is assembled with the components to provide the system. In a specific embodiment of this method described here, dust is removed from the fan of a notebook computer system by injecting compressed air into the port and through the conduit to expel the dust from the fan and to the exterior of the system.

In the drawings and specifications there has been set forth preferred embodiments of technology and, although specific terms are used, the description thus given uses terminology in a generic and descriptive sense only and not for purposes of limitation.

What is claimed is:

1. Apparatus comprising:
an electronic device having a housing;
electronic device components housed within said housing; and
a fluid flow conducting conduit communicating with one of said components housed within said housing;
said conduit enabling conduction to said one component of a flow of pressurized fluid which removes accumulated debris from said device.

2. Apparatus according to claim 1 wherein said apparatus is a computer system.

3. Apparatus according to claim 1 wherein said apparatus is a notebook computer system.

4. Apparatus according to claim 1 further comprising an external port disposed at a location on said housing and communicating with said one component, said port providing an access from outside said housing for the introduction of pressurized fluid.

5. Apparatus according to claim 4 wherein said housing defines a peripheral edge, said port is located along said peripheral edge, and said conduit is a tubular element extending from said port to said one component.

6. Apparatus according to claim 1 wherein said one component is a fan which circulates cooling air through said housing.

7. Apparatus according to claim 6 wherein said fan communicates with the exterior of said housing and further wherein conduction of a flow of pressurized fluid through said conduit to said fan expels accumulated debris from said fan and to the exterior of said housing.

8. Apparatus according to claim 1 wherein said apparatus is a computer system and said one component is an element which transfers heat from a second component within said housing to the exterior of said housing, and further wherein said conduit extends from adjacent an exterior surface of said housing to said heat transfer element and conducts a flow of pressurized gas to said element which cleans said element of accumulated debris.

9. Apparatus comprising:
a computer system having a housing which defines an exterior surface;
a computer system component housed within said housing and which is susceptible to accumulation of operation impeding debris;
a fluid flow conducting conduit within said housing and communicating with said computer system component; and
an external port disposed at a location on said exterior surface of said housing and communicating with said conduit, said port providing an access from outside said housing which enables the introduction of a pressurized gas;
said conduit conducting to said computer system component a flow of pressurized gas which removes accumulated debris from said computer system.

10. Apparatus according to claim 9 wherein said one component is a fan which circulates cooling air within said housing, and further wherein said conduit extends from a peripheral edge of said housing to said fan and conducts a flow of pressurized gas to said fan which cleans said fan of accumulated debris.

11. Apparatus according to claim 10 said fan communicates with the exterior of said housing and further wherein conduction of a flow of pressurized gas through said conduit to said fan expels accumulated debris from said fan and to the exterior of said housing.

12. Apparatus according to claim 9 wherein said computer system is a notebook computer system.

13. Apparatus according to claim 9 wherein said housing defines an exterior peripheral edge and further comprising an external port disposed at a location on said edge and communicating with said conduit, said port providing an access from outside said housing for the introduction of pressurized gas and further wherein said conduit is a tubular element extending from said port to said fan.

14. Method comprising:
providing a housing for an electronic device which has a plurality of components and a fluid flow conducting conduit extending within the housing to a component within the housing; and
enabling the removal of accumulated debris from the component by directing a flow of pressurized fluid through the conduit to the component.

15. Method according to claim 14 wherein the removal of debris comprises injecting a compressed gas through the conduit.

16. Method according to claim 14 wherein the removal of debris comprises blowing debris from the component.

17. Method according to claim 14 wherein the removal of debris comprises blowing dust from a fan which circulates cooling air within the housing.

18. Method according to claim 14 wherein the step of providing a housing comprises assembling a computer system housing and enclosing within the housing computer system components including a device which transfers heat from a component to the exterior of the housing.

19. Method according to claim 18 wherein the step of providing a housing comprises assembling a notebook computer system housing and providing in a peripheral edge of the assembled housing an external port communicating with the conduit.

20. Method according to claim 19 wherein the removal of debris comprises applying a pressurized gas to the external port to blow dust from a fan which circulates air within the housing and expel the dust to the exterior of the housing.
